(19) United States
(12) Patent Application Publication
(10) Pub. No.: US 2005/0204372 A1
(43) Pub. Date: Sep. 15, 2005

(54) Playback apparatus with flame-actuated switch

(76) Inventor: Seungsoo Lee, Monroe, NJ (US)

Correspondence Address: MCCARTER & ENGLISH, LLP, FOUR GATEWAY CENTER, 100 MULBERRY STREET, NEWARK, NJ, 07102, US

(21) Appl. No.: 11/071,070

(22) Filed: Mar. 3, 2005

Related U.S. Application Data
(60) Provisional application No. 60/549,661, filed on Mar. 3, 2004.

(51) Int. Cl. G11B 7/00

(52) U.S. Cl. 720/601

(57) ABSTRACT

The present invention relates to an apparatus for playing back a recording. More particularly, the apparatus includes a candle and a playback device having a receiving mechanism for receiving a storage medium having a recording stored therein for playback by the device. The receiving mechanism is adapted to removably receive the storage medium such that the storage medium can be replaced by another storage medium with a different recording. An enabling mechanism is provided for enabling the device to play the recording stored in the storage medium when the candle is lit. The enabling means disables the device when the candle is not lit. In accordance with one preferred embodiment of the present invention, the device is a compact disc player.

### CROSS-REFERENCE TO RELATED APPLICATION

This application claims the priority of U.S. Provisional Patent Application No. 60/549,661 filed Mar. 3, 2004, the disclosure of which is incorporated herein by reference in its entirety.

### FIELD OF THE INVENTION

The present invention relates to devices for playing back recordings and, more particularly, to playback devices equipped with candles.

### BACKGROUND OF THE INVENTION

Devices which are fitted with candles and which emit pre-selected sounds, such as a voice raised in song, an instrumental musical piece, etc. have been developed in the past (see, for instance, U.S. Pat. Nos. 4,477,249, 4,568,269, 4,983,119, 5,015,175, 5,622,490, 5,921,767, 6,050,812, 6,074,199, and 6,491,516, and Korean Utility Model Reg. No. 0313523). With respect to such devices and/or similar devices, the consumer's choices of sounds to which he or she may listen are either restricted to those sounds which are selected in advance, e.g., by the manufacturer, and incorporated (e.g., permanently) into the device prior to wholesale and/or retail sale, or otherwise limited such that the consumer's preferences as to the sounds emitted by the device are not accommodated in a convenient and/or economical manner. Furthermore, the candle portions of some of these devices are generally not easily detached from the remainder of the device, and/or easily replaceable by a different candle portion. The present invention addresses these and other limitations.

### SUMMARY OF THE INVENTION

The present invention overcomes the disadvantages and shortcomings of the prior art discussed above by providing a new and improved apparatus for playing back a recording stored in a storage medium. More particularly, the apparatus includes a candle and a playback device having a receiving mechanism for receiving a storage medium having a recording stored therein for playback by the device. The receiving mechanism is adapted to removably receive the storage medium such that the storage medium can be replaced by another storage medium with a different recording. An enabling mechanism is provided for enabling the device to play the recording stored in the storage medium when the candle is lit. The enabling means disables the device when the candle is not lit. In accordance with one preferred embodiment of the present invention, the device is a compact disc player.

### BRIEF DESCRIPTION OF THE DRAWINGS

For a more complete understanding of the present invention, reference is made to the following detailed description of exemplary embodiments considered in conjunction with the accompanying drawings, in which:

FIG. 1 is a perspective view of an audio playback/candle assembly constructed in accordance with a first embodiment of the present invention, the audio playback/candle assembly having a candle assembly and a compact disc (CD) player;

FIG. 2A is a partial cross-sectional view, taken along section line 2A-2A and looking in the direction of the arrows, of the audio playback/candle assembly shown in FIG. 1;

FIG. 2B is a view similar to FIG. 2A, except that the candle assembly is shown detached from the CD player.

FIG. 3 is a perspective exploded view of the audio playback/candle assembly shown in FIG. 1;

FIG. 4A is a bottom plan view of the candle assembly of the audio playback/candle assembly shown in FIG. 1;

FIG. 4B is a top plan view of the CD player of the audio playback/candle assembly shown in FIG. 1;

FIG. 5 is a perspective, partially exploded view of a modified version of an alignment mechanism utilized in the audio playback/candle assembly of FIG. 1 for properly orienting the candle assembly relative to the CD player;

FIG. 6 is a partial, cross-sectional view of the modified alignment mechanism shown in FIG. 5;

FIG. 7 is a partial, cross-sectional view of a modified version of an electrical connection mechanism utilized in the audio playback/candle assembly of FIG. 1 for electrically connecting the candle assembly to the CD player;

FIG. 8A is a partial, cross-sectional view of another modified version of the electrical connection mechanism of the audio playback/candle assembly shown in FIG. 1;

FIG. 8B is a top plan view of a pair of electrical contacts of the modified electrical connection mechanism shown in FIG. 8A and positioned on an upper surface of the CD player;

FIG. 9 is a side elevational view of a modified version of the CD player shown in FIG. 1;

FIG. 10 is a partial, cross-sectional view of an audio playback/candle assembly constructed in accordance with a second embodiment of the present invention;

FIG. 11 is a perspective, partially exploded view of the audio playback/candle assembly shown in FIG. 10;

FIG. 12 is a perspective view of a guide post utilized in the audio playback/candle assembly of FIGS. 10 and 11; and

FIG. 13 is a partial cross-sectional view of a modified version of a light-focusing lens arrangement utilized in the audio playback/candle of FIGS. 10 and 11.

### DETAILED DESCRIPTION OF THE INVENTION

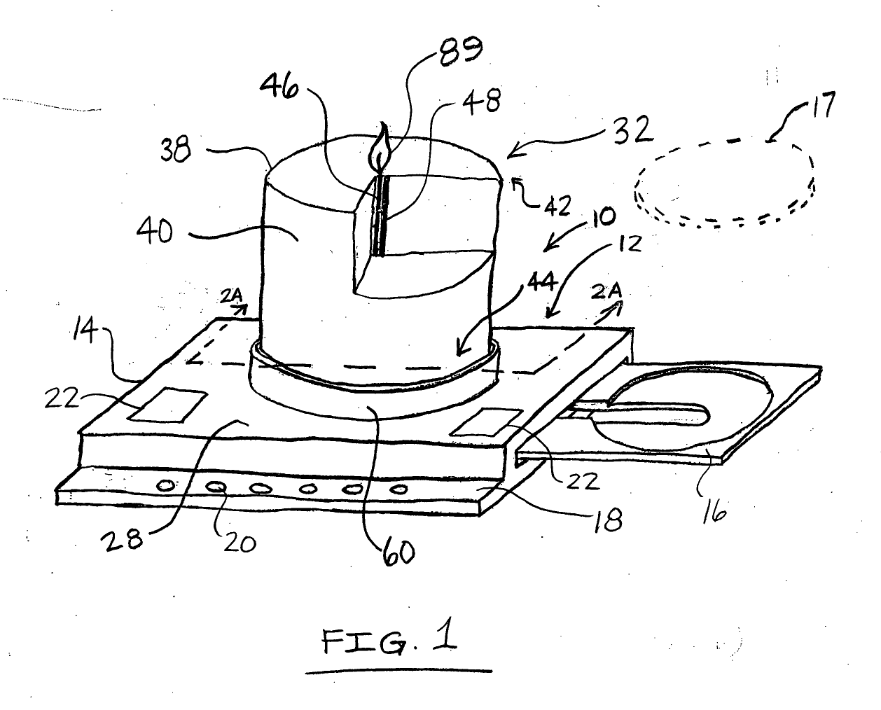

Referring to FIG. 1, there is shown an audio playback/candle assembly 10 constructed in accordance with a first embodiment of the present invention. The audio playback/candle assembly 10 includes a compact disc (CD) player 12 which has a construction and operation similar to those of a conventional CD player and which hence has conventional components. For instance, the CD player 12, which has a housing 14, includes a retractable CD tray 16 for loading a compact disc 17 (shown by broken line representation in FIG. 1) in the CD player 12 in a conventional manner. The CD player 12 further includes a control panel 18 which is positioned at one side of the housing 14 and which is provided with a plurality of buttons 20 (e.g., play, fast-forward, reverse, stop, search, next track, previous track, change CD buttons, etc.) for operating the CD player 12. In addition, the CD player 12 includes one or more speakers 22 mounted in the housing 14 for emitting the sounds of audio recordings stored on the compact disc being played by the CD player 12.

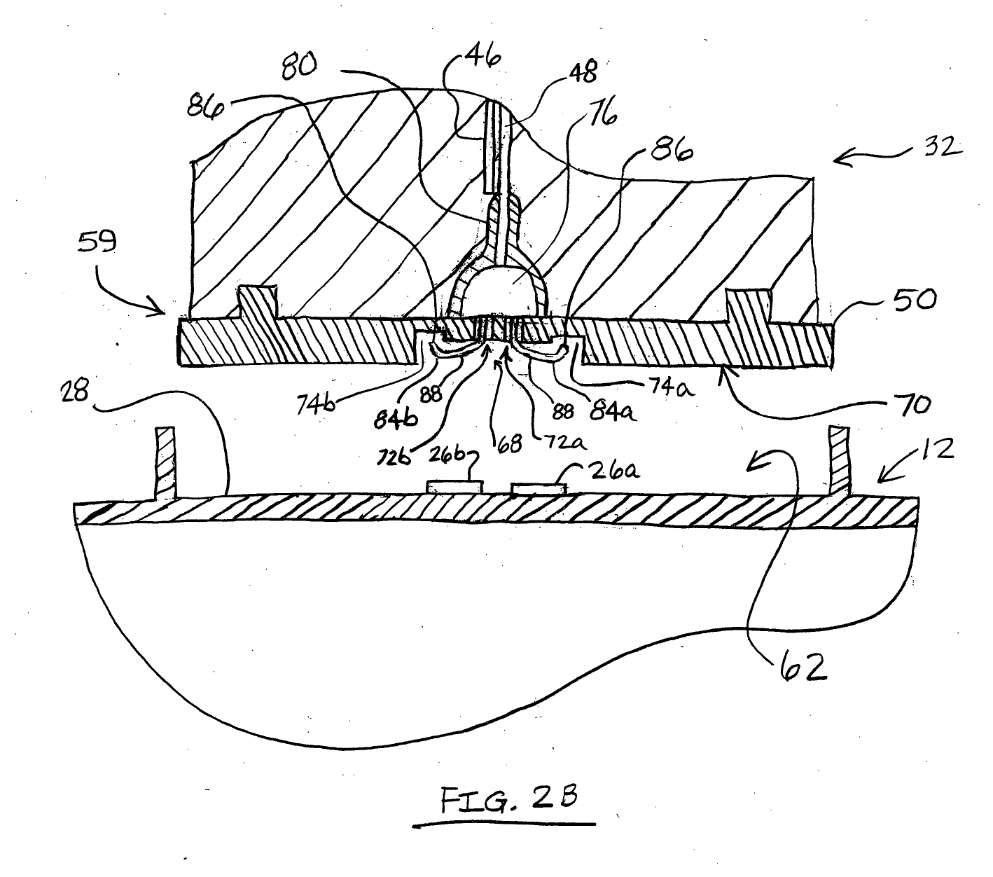

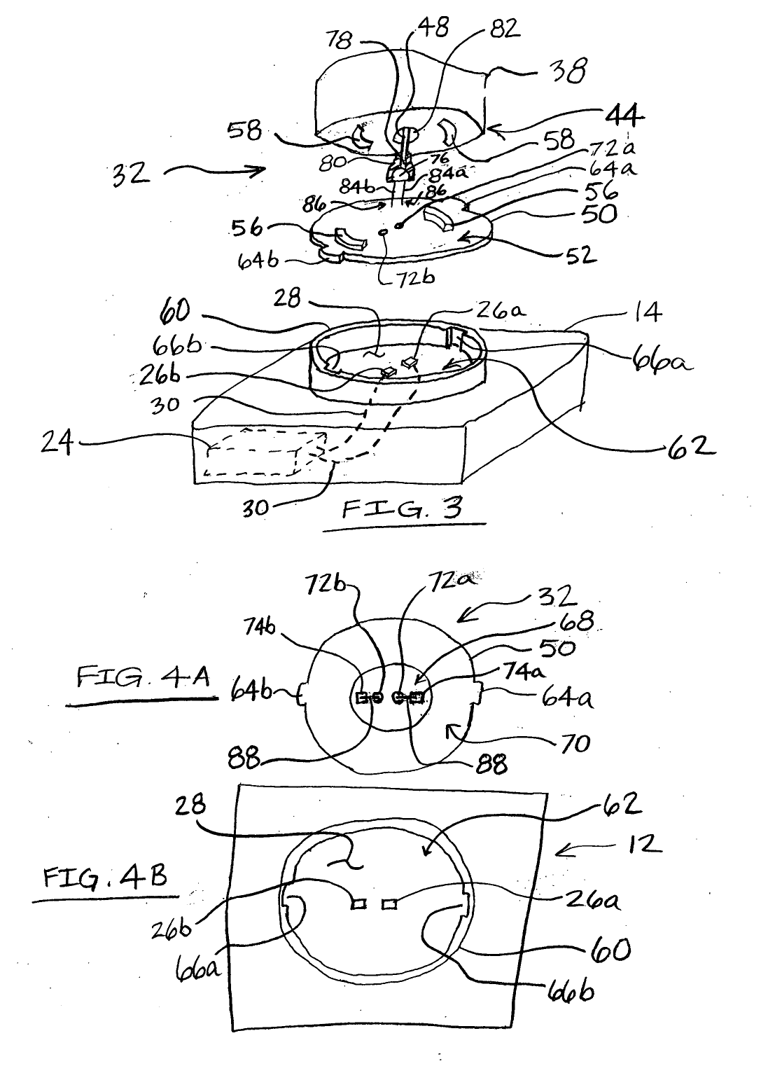

Now referring to FIGS. 1 and 3, the CD player 12 is equipped with circuitry 24 disposed within the housing 14 for providing electrical power to, and/or for controlling the operation of, the CD player 12. The CD player 12 further includes a pair of electrical contacts 26a, 26b disposed on and projecting from an upper surface 28 of the housing 14. Each of the electrical contacts 26a, 26b is connected to the circuitry 24 of the CD player 12 via any conventional electrical connecting mechanism 30 (e.g., electrical wire, a flexible printed circuit strip, etc.) housed within the housing 14. The circuitry 24 is configured so as to activate the CD player 12 and cause the same to play back a compact disc loaded therein in response to an electrical connection being established across the electrical contacts 26a, 26b (e.g., when the electrical contacts 26a, 26b are electrically closed).

Referring back to FIG. 1, the audio playback/candle assembly 10 further includes a candle assembly 32. The candle assembly 32 has a candle 38 which is equipped with conventional features such as a pillar-type body 40 having an upper end 42 and a lower end 44 (see also FIG. 3), and a wick 46 extending generally vertically within the body 40 between the upper and lower ends 42, 44. The candle 38 also includes an optical fiber 48 (see FIGS. 1 and 3) extending generally vertically within the body 40 between the upper and lower ends 42, 44 of the candle 38. As will be discussed further below, the optical fiber 48 is adapted to transmit light generated by the candle 38 downward through the body 40 for activating and/or turning on the CD player 12. The optical fiber 48 is constructed and disposed in the candle 38 in a conventional manner.

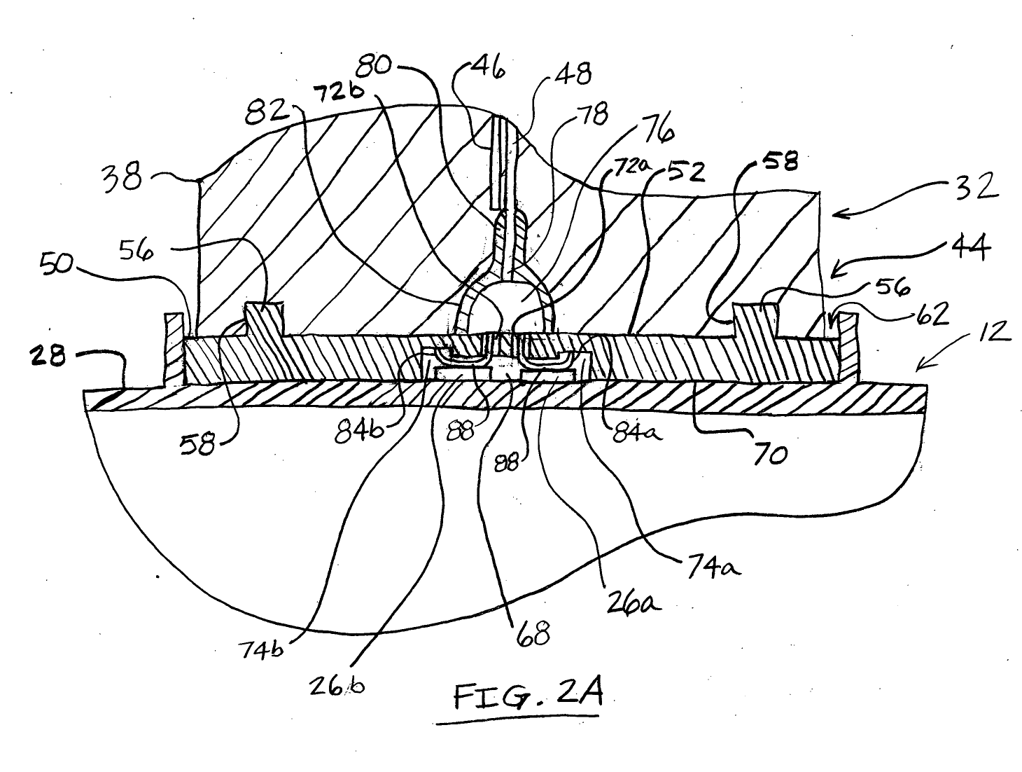

With reference to FIGS. 2A, 3 and 4A, the candle assembly 32 includes an end plate 50. The end plate 50 is coupled to the lower end 44 of the candle 38 for facilitating the proper placement of the candle assembly 32 on the upper surface 28 of the CD player 12. More particularly, the end plate 50 has an upper side 52 secured and/or affixed substantially permanently to the lower end 44 (see FIGS. 2A and 3) of the candle 38 in any suitable manner (e.g., with the use of a double sided tape, an adhesive such as glue or rubber cement, screws, brads, etc.). The end plate 50 also includes projections 56, each of which is adapted for insertion into a complementarily shaped cavity 58 formed in the lower end 44 of the candle 38. In addition to increasing the surface area available for use in affixing the candle 38 to the end plate 50, the projections 56 and cavities 58 cooperate to form male-female connections between the candle 38 and the end plate 50 which effectively prevent relative rotation therebetween.

Referring to FIGS. 1, 3 and 4B, a raised, generally annular lip 60 extends upwardly from the upper surface 28 of the CD player 12. The lip 60 defines a socket 62 (see also FIG. 2B) which is sized and shaped so as to receive a bottom end 59 (see FIG. 2B) of the candle assembly 12 (i.e., the end plate 50 and the lower end 44 of the candle 38). As shown in FIGS. 3, 4A and 4B, ears 64a, 64b extend outwardly from the end plate 50 in a generally radial direction, while keyways 66a, 66b are formed in an inner surface of the lip 60. The ears 64a, 64b and the keyways 66a, 66b form a keying arrangement that prevents rotational misalignment between the candle assembly 32 and the CD player 12. More particularly, the sizes and/or shapes of the ear 64a and the keyway 66a are such that the ear 64a is adapted to fit only into the keyway 66a (i.e., and not into the keyway 66b). Similarly, the sizes and/or shapes of the ear 64b and the keyway 66b are such that the ear 64b is adapted to fit only into the keyway 66b (i.e., and not into the keyway 66a). As a result, the bottom end 59 of the candle assembly 32 is prevented from entering the socket 62 of the CD player 12 unless and until the ears 64a, 64b of the end plate 50 are aligned directly above their respective matching keyways 66a, 66b of the lip 60. Other keying arrangements are possible, such as keying arrangements in which an irregular peripheral spacing of the ear/keyway pairings functions to orient the candle assembly 32 in a particular angular orientation relative to the CD player 12.

Now referring to FIGS. 2A and 4A, the end plate 50 includes a cavity 68 formed in a lower side 70 thereof (see also FIG. 2B). As shown in FIG. 2A, when the end plate 50 is seated within the socket 62 of the CD player 12, the electrical contacts 26a, 26b of the CD player 12 are aligned and disposed within the cavity 68. Referring to FIGS. 2A, 3 and 4A, the end plate 50 further includes a pair of through holes 72a, 72b extending therethrough between the upper and lower sides 52, 70 of the end plate 50 for purposes to be discussed hereinafter. The end plate 50 is also provided with a pair of depressions 74a, 74b (see FIGS. 2A and 4A) positioned within the cavity 68 adjacent the holes 72a, 72b, respectively.

Referring to FIGS. 2A and 3, the candle assembly 32 further includes a photo detector or sensor 76 which is mounted in the lower end 44 of the candle 38. The photo detector 76, which has a construction and operation similar to those of conventional photo detectors, is optically and/or physically coupled to a lower end 78 of the optical fiber 48 such that it can be actuated by light transmitted through the optical fiber 48. More particularly, when light having a predetermined level or levels of brightness is transmitted through the optical fiber 48 to the photo detector 76, it causes the photo detector 76 to change mode from an “open” mode to a “closed” mode. Conversely, when the transmission of light to the photo detector 76 is interrupted or terminated, the mode of the photo detector 76 is changed from its “closed” mode to its “open” mode. The nature, effect and/or purpose of such modes and such mode changes in the photo detector 76 will be discussed in greater detail hereinafter.

With reference to FIGS. 2 and 3, a boot 80 is mounted in the lower end 44 of the candle 38 for optically and/or physically connecting the optical fiber 48 to the photo detector 76. More particularly, the boot 80 forms a substantially light-tight enclosure surrounding the lower end 78 of the optical fiber 48, and at least the portion of the photo detector 76 that is adjacent thereto. The boot 80, which can be formed from an opaque material (e.g., a black rubber material) for superior light insulation, acts to prevent ambient light other than that transmitted by the optical fiber 48 from influencing the operation of (e.g., changing the mode of) the photo detector 76. The boot 80 further functions to inhibit transmitted light from leaking outward from the lower end 78 of the optical fiber 48, and/or from the photo detector 76 itself. As indicated above, the boot 80 maintains the lower end 78 of the optical fiber 48 in alignment with and/or in contact with the photo detector 76, thereby facilitating the transmission of light from the optical fiber 48 to the photo detector 76.

The photo detector 76 and the boot 80 are disposed within a cavity 82 (see FIGS. 2A and 3) formed in the lower end 44 of the candle 38. More particularly, the photo detector 76 and the boot 80 are encapsulated in the cavity 82 by the end plate 50 so as to further insulate the photo detector 76 from ambient light. In combination with the use of the boot 80, this arrangement has the effect of substantially completely shielding the photo detector 76 from the influence of ambient light, while simultaneously enhancing the effect of the light from the candle 38 on the mode and/or operation of the photo detector 76.

With reference to FIGS. 2B and 3, the photo detector 76 includes a pair of electrical leads 84a, 84b, each of which has an end 86, as is conventionally known. During fabrication of the candle assembly 32, the leads 84a, 84b of the photo detector 76 are passed, beginning with their respective ends 86, through the holes 72a, 72b, respectively, of the end plate 50, and into the cavity 68. The leads 84a, 84b are bent near where they emerge from the holes 72a, 72b, respectively, so that each of them extends in a lateral direction toward the corresponding adjacent depression 74a, 74b. The leads 84a, 84b are also bent near their respective ends 86 so that each end 86 extends at least partially upward toward the corresponding depression 74a, 74b and away from the lower side 70 of the end plate 50. As shown in FIG. 2B, this combination of bends in the leads 84a, 84b of the photo detector 76 functions to hold or secure the photo detector 76 to the end plate 50. In other words, the photo detector 76 is secured to the end plate 50 only by the leads 84a, 84b. Alternatively, additional securing mechanisms (e.g., glue, etc.) can be utilized. In addition, because the leads 84a, 84b are contained thereby within the cavity 68, the ends 86 of the leads 84a, 84b are prevented from coming in contact with the skin or clothing of a user, and/or any surface upon which the candle assembly 32 may be placed (e.g., temporarily, before placement of the candle assembly 32 on the CD player 12). Further, in circumstances in which the candle assembly 32 is packaged and/or sold separately from the CD player 12, due to this lead bend/cavity arrangement, the ends 86 of the leads 84a, 84b are prevented from being damaging to, and/or becoming damaged by, any packaging materials.

With reference to FIGS. 1-4B, in use, the CD player 12 is placed on a stable surface, such as the surface of a shelf or table. A compact disc (CD) is placed on the tray 16 of the CD player 12, and the tray 16 is caused to retract into the housing 14 of the CD player 12 together with the CD. The candle assembly 32 is then placed above the CD player 12 in a predetermined angular orientation (i.e., the candle assembly 32 is keyed to the CD player 12) such that the ears 64a, 64b of the end plate 50 are aligned with the keyways 66a, 66b, respectively, of the lip 60 of the CD player 12. Next, the candle assembly 32 is lowered into the socket 62 formed by the lip 60 of the CD player 12.

The above-described keying arrangement between the candle assembly 32 and the CD player 12 provides that, as the candle assembly 32 is lowered into the socket 62 of the CD player 12, the lead 84a of the photo detector 76 is positioned directly above the electrical contact 26a of the CD player 12, while the lead 84b of the photo detector 76 is positioned directly above the electrical contact 26b of the CD player 12. As such, when the end plate 50 seats in the socket 62, contact between the lead 84a and the electrical contact 26a, and contact between the lead 84b and the electrical contact 26b, are established automatically. This result is required in at least some examples of the candle assembly 32 in which the photo detector 76 either will not function unless it is connected to the CD player 12 in a particular orientation related to the polarity of its leads 84a, 84b, or will be susceptible to damage if used in an orientation that contravenes its polarity. In some other examples, this result is not required, and the candle assembly 32 can be configured such that each of the leads 84a, 84b can be connected to any one of the electrical contacts 26a, 26b.

Referring back to FIGS. 2A and 2B, as the candle assembly 32 is lowered into the socket 62 of the CD player 12, the leads 84a, 84b of the photo detector 76 come in contact with the electrical contacts 26a, 26b, respectively. The weight of the candle 38 then causes the leads 84a, 84b, which are prevented from moving any further downward by the electrical contacts 26a, 26b, respectively, to flex upward and/or outward. Finally, when the candle assembly 32 is seated on the CD player 12, the leads 84a, 84b, being flexed against the electrical contacts 26a, 26b, respectively, assume the shapes and positions shown in FIG. 2A, e.g., in which the ends 86 of the leads 84a, 84b protrude into a corresponding one of the depressions 74a, 74b of the end plate 50, and extended portions 88 of the leads 84a, 84b are in contact with the electrical contacts 26a, 26b, respectively. Such an arrangement is advantageous in that proper seating of the candle assembly 32 in the socket 62 of the CD player 12 functions to maintain electrical continuity between the leads 84a, 84b of the photo detector 76 and hence the electrical contacts 26a, 26b of the CD player 12 during normal use.

As discussed above, the photo detector 76 is configured to assume an “open” mode when it fails to detect light transmitted by the optical fiber 48 (i.e., when the candle 38 is not lit). In its open mode, the photo detector 76 effectively prevents current flow between its leads 84a, 84b and hence between the electrical contacts 26a, 26b of the CD player 12, thereby causing the CD player 12 to be in its deactivated or “off” state (i.e., the CD player 12 does not operate).

When the candle 38 is lit, the CD player 12 is activated. More particularly, light from a flame 89 (FIG. 1) at the top of the wick 46 is received by the optical fiber 48 in a conventional way, and is thereafter transmitted by the optical fiber 48 to the photo detector 76 of the candle assembly 32. In response, the photo detector 76 assumes its “closed” mode from its “open” mode. In its “closed” mode, the photo detector 76 permits current flow between the leads 84a, 84b, thereby creating an electrical connection across the electrical contacts 26a, 26b of the CD player 12. In response, and as is discussed above, the circuitry 24 activates the CD player 12 (i.e., the CD player 12 is turned on). When an appropriate button of the control panel 18 is actuated, the CD player 12 begins to play back, e.g., through the speakers 22, an audio recording stored on the previously loaded CD. Alternatively, the CD player 12 can be configured such that it automatically begins to play the CD in response to the photo detector's mode change.

Once the CD player 12 has begun to play the CD, it may be caused to continue to play the CD, e.g., via maintaining the existence of the flame 89. Thereafter, the CD player 12 may be caused to cease playback of the CD, e.g., via extinguishment of the flame 89. Extinguishment of the flame 89 interrupts transmission of candlelight by the optical fiber 48. Deprived of light from the candle 38, the photo sensor 76 changes from its closed mode and reassumes its open mode, thereby breaking the electrical connection previously created across the electrical contacts 26a, 26b of the CD player 12 and hence deactivating the CD player 12 (i.e., turning the CD player 12 off). The CD player 12 can also be caused to terminate playback of the CD by actuating the control panel 18.

In cases where the user either permits the candle 38 to burn unattended, or simply decides not to extinguish the flame 89, the candle 38 is configured so as to burn itself out in a conventional manner (e.g., as a result of the consumption of its entire wick 46). In accordance with the present invention, the candle 38 can be configured so as to burn itself out before being reduced in height below about 1-2 inches. This feature is provided not only for safety purposes, but also for purposes of maintaining the appearance and proper function of the CD player 12. For example, when adequate spacing is maintained between the flame 89 of the candle 38 and the upper surface 28 of the CD player 12, discoloration and/or charring of the latter is avoided. For another example, the shape and/or size of the candle 38 may be adapted such that as the candle 38 burns out, molten wax is substantially prevented from flowing onto the housing 14 of the CD player 12. The latter concern may be addressed in other ways. For example, particular examples of the candle 38 in accordance with the present invention are constructed of modern wax materials such that the candle 38 does not tend to produce molten wax in large enough quantities to create an overflow.

In cases where the user intentionally extinguishes the flame 89 to deactivate the CD player 12, the user may choose to keep the candle assembly 32 mounted on the CD player 12 for future use. Alternatively, if the candle 38 has burned itself out, or even before the candle 38 has been consumed, the candle assembly 32 may be detached and/or removed from the CD player 12 by lifting the same vertically from the CD player 12, and be replaced at any time with a new and/or different candle assembly, e.g., according to the whims and/or changing preferences of the user.

It should be appreciated that the audio playback/candle assembly 10 of the present invention provides numerous advantages over the prior art discussed above. For instance, the user's options as to the audio recordings to be played back in response to the lighting of the candle 36 are not limited to those chosen in advance by the manufacturer. To the contrary, in accordance with the present invention, the user may use the audio playback/candle assembly 10 in conjunction with any or all CDs he or she may own and/or to which he or she may choose to listen. Moreover, the audio playback/candle assembly 10 is configured so as to permit the use of relatively large, and therefore relatively bright, but also heavy candles 38. The relative brightness of such large candles, along with their tendency to last longer, increases their utility for purposes of illumination and/or the setting a ‘mood’ or the creation of a desired ambience or atmosphere on the part of the user. The relatively heavy weight of such large candles ensures adequate flexure of the leads 84a, 84b of the photo detector 76, contributing to an electrical connection arrangement which is both simple and, from a standpoint of mass production, relatively economical.

The ability on the part of the user to easily detach a spent candle assembly 32 from the CD player 12, and/or to replace the same with a new candle assembly 32 without replacing the CD player 12, results in increased economic efficiency. More specifically, the design of the CD player 12 may be optimized for durability and repeated use over a relatively long life span, while the design of the consumable candle assembly 32 may be optimized so as to minimize unit manufacturing cost and/or ensure a low enough wholesale or retail price so as to promote demand for replacement candle assemblies. At the same time, a variety of candle assemblies 32 may be offered for sale, e.g., having different colors, shapes, and/or aromas (e.g., as in aromatherapy candles) so as to suit the preferences and/or creative tendencies of a wide variety of potential users.

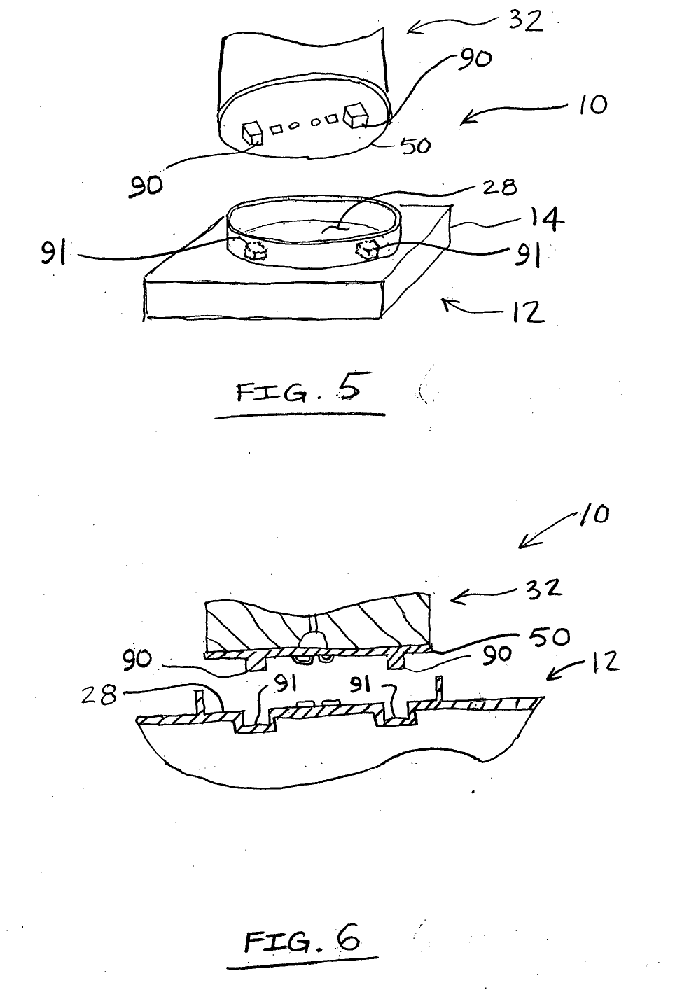

It should be noted that audio playback/candle assembly 10 of the present invention can have numerous modifications and variations. For instance, the ears 64a, 64b (see FIG. 4A) of the end plate 50 and the associated keyways 66a, 66b (see FIG. 4B) of the lip 60 of the CD player 12 may be eliminated and/or replaced with other securing/aligning mechanisms. By way of example, and with reference to FIGS. 5 and 6, the audio playback/candle assembly 10 can be provided with one or more downward protrusions 90 depending from the end plate 50 and one or more complementary cavities 91 formed in the upper surface 28 of the housing 14 of the CD player 12. More particularly, the protrusions 90 can be inserted into the cavities 91 during mounting of the candle assembly 32 on the CD player 12. Each such pairing of a protrusion 90 with a cavity 91 in accordance with such an arrangement may exhibit an unique size, shape, and/or location so as to maintain the above-described “keying” scheme between the candle assembly 32 and the CD player 12.

In accordance with further modifications to the audio playback/candle assembly 10 of the present invention, the ends 86 of the leads 84a, 84b of the photo detector 76, rather than being caused to extend unsupported into depressions 74a, 74b of the end plate 50 (see FIG. 2A), can instead be soldered or otherwise attached to anchoring hardware (e.g., rivets, conductive posts, etc. coupled to the end plate 50). In some such examples, it is not the leads 84a, 84b themselves, but separate electrical contacts (e.g., electrical contacts that are connected to or integral with the anchoring hardware) that interact with the electrical contacts 26a, 26b of the CD player 12. By forgoing the use of the axial leads 84a, 84b of the photo detector 76 as electrical contacts, detent-type pairings of opposing electrical contacts can be employed (e.g., convex/concave pairings), as well as other similar modifications to the end plate 50 and the upper surface 28 of the CD player 12 (e.g., including bayonet locking features, retention blocks, stoppers, etc.). Such features permit the candle assembly 32 to be removably secured to the upper surface 28 of the CD player 12 without first being keyed to the CD player 12, and then rotated until the detent is actuated (e.g., indicating proper electrical contact alignment). In accordance with some such modifications to the interface between the candle assembly 32 and the CD player 12, the candle assembly 32 is releasably locked in place atop the CD player 12, such that the candle assembly 32 cannot be pulled out of the socket 62 without first being rotated with respect to the CD player 12 to release the detent and/or locking mechanisms. Other locking or latching mechanisms (e.g., clips, etc.) can also be utilized.

Other electrical connector mechanisms can also be used for removably connecting the photo detector 76 of the candle assembly 32 to the switch circuitry 24 of the CD player 12. As shown in FIG. 7, the leads 84a, 84b (FIG. 2A) of the photo detector 76 can be terminated at respective male contacts 92 which extend downward from the end plate 50. The male contacts 92 are sized and shaped so as to be inserted into and achieve electrical contact with complementary female sockets 94 provided in the CD player 12.

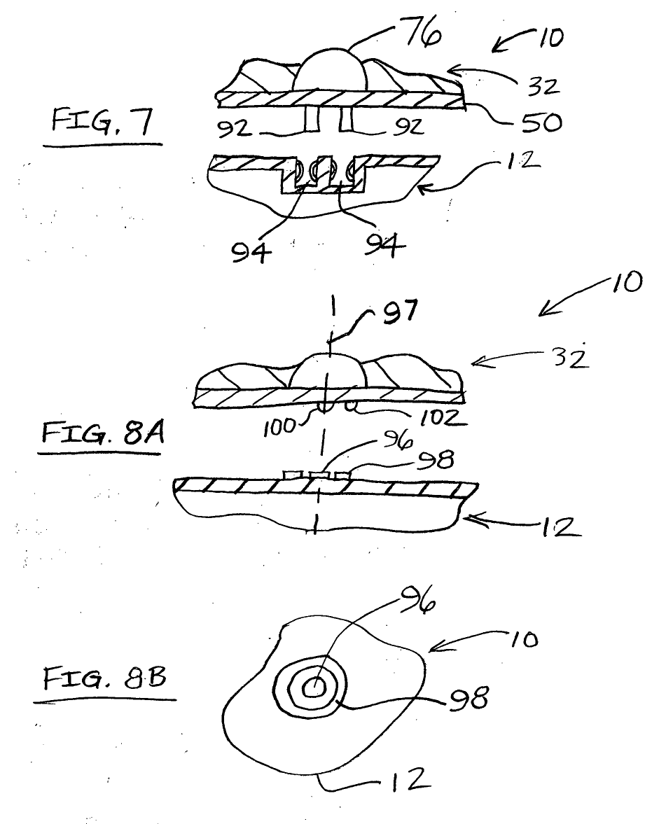

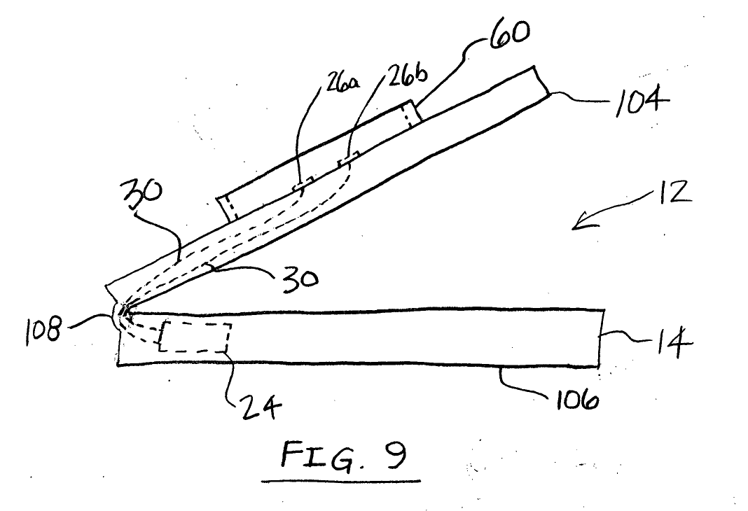

While the modified electrical contact arrangement illustrated in FIG. 7 may still require keying between the candle assembly 32 and the CD player 12, other modified electrical connector arrangements require no such keying, whether before or after mounting of the candle assembly 32 on the CD player 12. For instance, and as shown in FIGS. 8A and 8B, the side-by-side arrangement of the electrical contacts 26a, 26b of the CD player 12 may be replaced by an electrical contact 96 which is disposed along an axis of rotation 97 of the candle assembly 32, and an electrical contact 98 which is in the form of a ring surrounding the electrical contact 96. Complementary electrical contacts 100, 102 may be provided on the candle assembly 32 such that electrical continuity is maintained regardless of the angular orientation of the candle assembly 32. The same effect is achieved by a different modification to the audio playback/candle assembly 10 in which a single male post containing two separate electrical contacts is inserted into a complementary female socket, wherein the female socket is configured similarly to a conventional headphone jack.

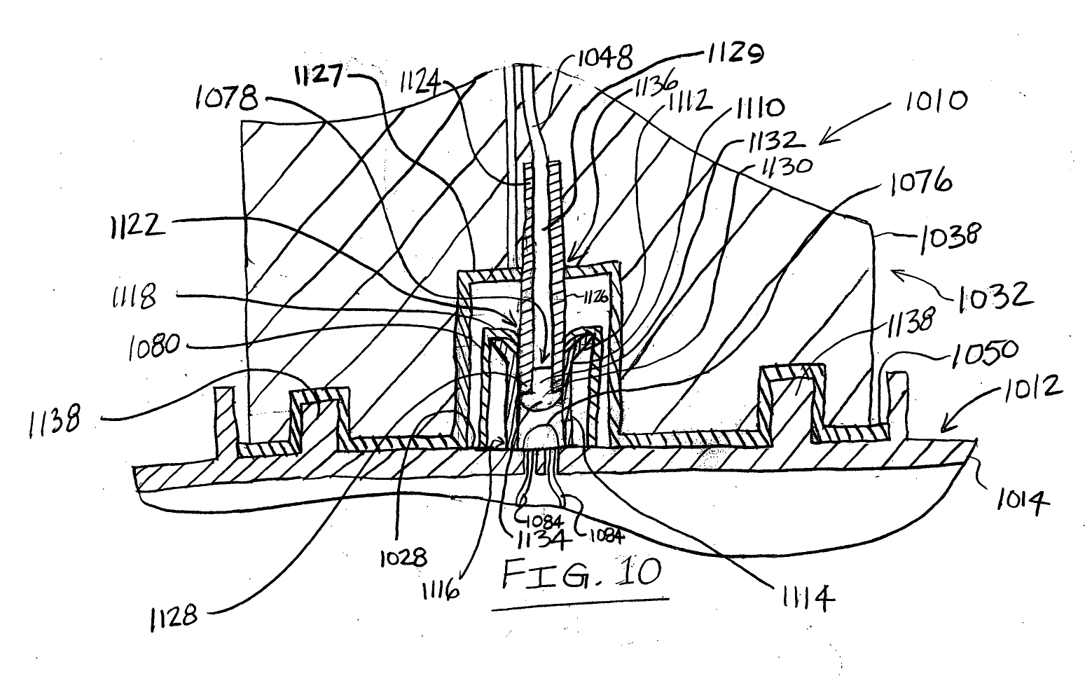

Other possible modifications of the CD player 12 include replacing the simple extendable/retractable CD receiving tray 16 (see FIG. 1) with a rotating platform (not shown), also extendable and retractable, but having the capacity to store multiple discs within the CD player 12. Alternatively, and as shown in FIG. 9, the tray 16 (see FIG. 1) of the CD player 12 may be eliminated and/or replaced with a flip-top cover 104 which is pivotally mounted to the housing 14 of the CD player 12. The flip-top cover 104 can be configured so as to ordinarily be biased open but also so as to be held down (i.e., held closed) by the weight of the candle assembly 32 mounted thereon or by a releasable latching mechanism. The flip-top cover 104 can also include the lip 60, and the electrical contacts 26a, 26b for making electrical contact with the candle assembly 32. Electrical connections between the electrical contacts 26a, 26b on the flip top cover 104 and the circuitry 24 mounted in the housing 14 of the CD player 12 can be made by passing flexible wires 30 (or other flexible connectors such as a pair of conductors formed within a conventional flexible printed circuit strip), through and/or along a hinge 108 located between the flip-top cover 104 and the housing 14.

The CD player 12 can also include one or more flame-resistant external surfaces so as to ensure compatibility with the use of the candle 38. For example, surfaces of and/or near the lip 60 of the housing 14 of the CD player 12 may be made from a conventional flame-retardant material.

It should also be noted that the CD player 12 can be configured such that the photo detector 76 acts as a simple power switch that functions to connect and/or interrupt the electrical power used by the CD player 12 to play CDs. Any conventional source for electrical power may be utilized, e.g., battery power, A/C power supplied according to either the European or U.S. A/C voltage standards, etc. The CD player 12 can also be configured so that certain functions (e.g., CD changing function, track selection/search function, etc.) are enabled even when the candle 38 is not lit. The CD player 12 can also be equipped with a switch for entirely bypassing the photo sensor 76 (e.g., so that the CD player 12 can be in operation even when the candle 38 is not lit).

The CD player 12 of the audio playback/candle assembly 10 may be eliminated and/or replaced with a similarly configured playback device for playing back audio and/or video recordings stored on and/or in one or more recording storage mediums other than a compact disc. Examples of such playback devices include DVD players, MP3 players, audio or video cassette decks, portable stereos (i.e., so-called ‘boom boxes’), all-in-one stereos or ‘ministereos’, and/or a clock radio, etc. Other examples include a personal computer configured to play back audio and/or video recordings stored in the form of digital files (e.g., stored in electronic memory or other storage media).

Whether the audio playback device of the audio playback/candle assembly 10 is a CD player or not, the audio playback device can preferably be compact, lightweight, and/or portable in nature. For example, the audio playback device can be a portable CD player, a portable analog or digital audiotape player, a portable analog or digital videotape player, and/or a portable player of digital audio files such as a portable MP3 player, a palm-top computer, and/or a laptop computer. Other audio and/or video playback devices may be similarly configured.

The audio playback device of the audio playback/candle assembly 10 can be configured so as to lack the capacity to store audio recordings, whether in the form of discs, tapes, and/or other memory units that perform such a function. For instance, the audio playback/candle assembly 10 can include radio-type audio playback devices such as a transistor radio, a tuner/amplifier of a high-fidelity stereo set, and/or a device for receiving and playing digital radio broadcasts. Other examples include televisions, computers used in streaming audio mode, and/or stereo speakers.

The audio playback/candle assembly 10 may further be configured to store and play back one or more prerecorded and/or pre-programmed audio recordings. In some such examples of the audio playback/candle assembly 10, the CD player 12 is replaced by an otherwise similarly configured device for playing back the prerecorded and/or pre-programmed audio recording in response to the lighting of the candle 38.

The audio playback/candle assembly 10 can also be modified so as not to include the speakers 22. For instance, the audio playback/candle assembly 10 can be connected to external speakers (e.g., via speaker wire) or a headphone.

The candle assembly 32 of the audio playback/candle assembly 10 may be further modified so as to eliminate the optical fiber 48 and the photo detector 76, and to replace the same with other switching apparatuses and/or flame-sensing mechanisms that do not operate via the transmission of candlelight. For instance, the candle assembly 32 may be equipped with a thermoresponsive piezoelectric strip, e.g., as described in U.S. Pat. No. 5,015,175, or a thermistor strip, e.g., as described in U.S. Pat. No. 4,983,119. Numerous other types of switches and/or sensing mechanisms can be employed.

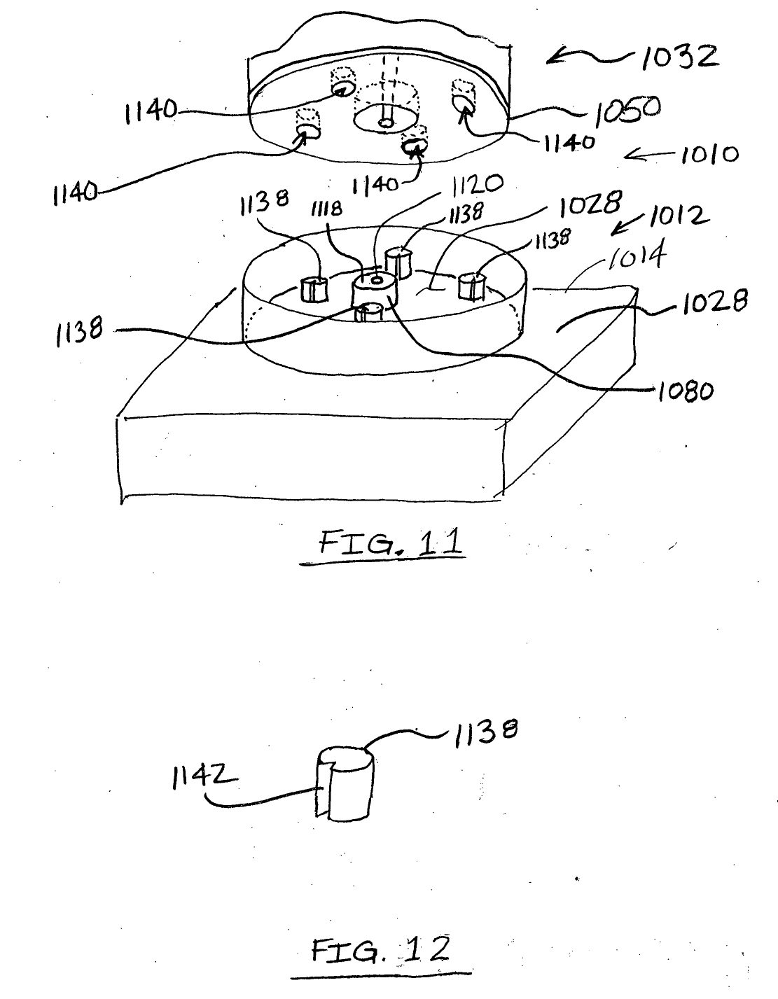

A second exemplary embodiment of the present invention is illustrated in FIGS. 10-13. Elements illustrated in FIGS. 10-13 which correspond substantially to the elements described above with reference to FIGS. 1-9 have been designated by corresponding reference numerals increased by one thousand. The embodiment of the present invention shown in FIGS. 10-13 operates and is constructed in manners consistent with the foregoing description of the audio playback/candle assembly 10 shown in FIGS. 1-9, unless it is stated otherwise.

In FIGS. 10-12 is shown an audio playback/candle assembly 1010 constructed in accordance with a second embodiment of the present invention. Unlike the embodiment of FIGS. 1-9, the audio playback/candle assembly 1010 has a photo detector 1076 which, rather than being a part of a candle assembly 1032, is instead a part of a CD player 1012, being mounted to an upper surface 1028 of a housing 1014 thereof. More particularly, the CD player 1012 includes a fiber guide 1110 mounted on the upper surface 1028 and having a funnel portion 1112 for receiving an end 1078 of an optical fiber 1048 extending downward from the candle assembly 1032. The fiber guide 1110 also has a cylindrically-shaped portion 1114 for guiding the end 1078 of the optical fiber 1048 into optical connection with the photo detector 1076, which is disposed at a lower end 1116 of the fiber guide 1110. The CD player 1012 further includes a boot 1080 which is mounted on the upper surface 1028 of the CD player 1012 and which includes an upper portion 1118 having an opening 1120 (see FIG. 11) for receiving the end 1078 of the optical fiber 1048 and for forming a light-tight seal around the optical fiber 1048 (e.g., as reflected in a downward flexure 1122 of the upper portion 1118 of the boot 1080 as produced by the insertion of the optical fiber 1048 therethrough).

The audio playback/candle assembly 1010 includes other features adapted to improve the quality and/or reliability of the optical connection between the candle assembly 1032 and the CD player 1012, and more specifically, the optical connection between the end 1078 of the optical fiber 1048 and the photo detector 1076. For instance, the candle assembly 1036 includes a guiding tube 1124 (see FIG. 10) at least partially embedded within a body 1040 of a candle 1038 of the candle assembly 1032. More particularly, the guiding tube 1124 has an exposed portion 1126 extending downward through a raised column section 1127 of the end plate 1050 of the candle assembly 1032, and an end 1128 which is removably disposed in the fiber guide 1110. The guiding tube 1124 accommodates, in a sleeve-like manner, a substantially coextensive lower portion 1129 of the optical fiber 1048. Mounted at the end 1128 of the guiding tube 1124 is a lens device 1130 having a lens trunk 1132 extending into the guiding tube 1124 for receiving transmitted candlelight from the end 1078 of the optical fiber 1048. The lens device 1130 also includes a lens 1134 positioned above the photo detector 1076 so as to direct the transmitted candlelight on the photo detector 1076. In one or more examples of the audio playback/candle assembly 1010, the lens 1134 is separated from the photo detector 1076 by a distance corresponding approximately to a focal length of the lens 1134. In other examples, the lens 1134 is separated from the photo detector 1076 by a distance somewhat smaller or somewhat greater than the focal length of the lens 1134.

The guiding tube 1124 is sufficiently stiff to permit a user mounting the candle assembly 1032 on the CD player 1012 to push the optical fiber 1048 into the opening 1120 (see FIG. 11) in the upper portion 1118 of the boot 1080 and thereafter into the funnel portion 1112 of the fiber guide 1110 while the upper portion 1118 of the boot 1080 flexes under the frictional force of the resulting seal between the boot 1080 and the guiding tube 1124. At the same time, the guiding tube 1124 is sufficiently thin and/or is flexible enough to cure minor misalignments (e.g., misalignment such as may arise within acceptable dimensional tolerances) between an axis (not shown) of a hole 1136 formed in the end plate 1050 through which the optical fiber 1048 passes, and a longitudinal axis (not separately shown) of the cylindrically-shaped portion 1114 of the fiber guide 1110. Moreover, the lens 1134 is configured so as to cure such minor axial misalignments as may exist (e.g., even with the use of the guiding tube 1124 and the fiber guide 1110), between the lower end 1078 of the optical fiber 1048 and the photo detector 1076 mounted on the end plate 1050.

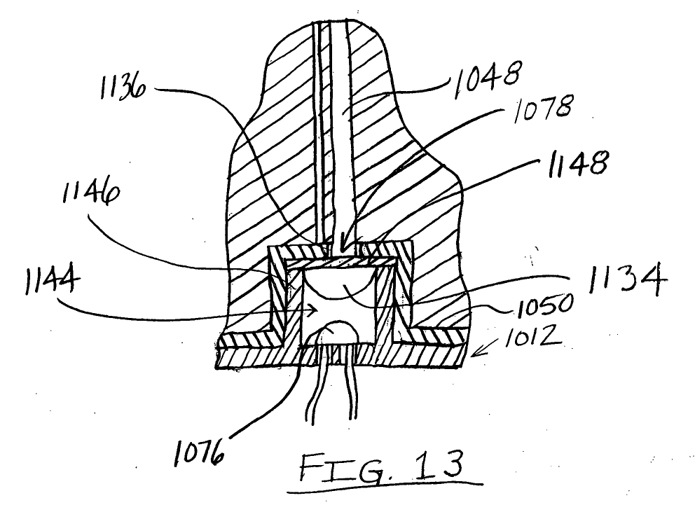

As shown in FIGS. 10-12, the housing 1014 of the CD player 1012 further includes an array of guide posts 1138, while the end plate 1050 of the candle assembly 1032 includes a complementary array of guide pockets 1140. The guide posts 1138 are shaped, sized, and located so as to be inserted into the guide pockets 1140 when the candle assembly 1032 is mounted on the CD player 1012, providing adequate initial alignment between the lens-equipped end 1078 of the optical fiber 1048 and the opening 1120 in the upper portion 1118 of the boot 1080. The guide posts 1138 include air flow channels 1142 (see FIG. 12) to facilitate insertion and removal of the guide posts 1138 from the guide pockets 1140 by preventing air pressure buildup during insertion, and/or vacuum pressure resistance during removal. Although the same is not shown in FIG. 10, the guiding tube 1124 can be provided with a similar air flow channel to prevent air pressure buildup during insertion of the guiding tube 1124 into the boot 1080 and/or the fiber guide 1110, and/or to prevent vacuum pressure resistance during removal of the guiding tube 1124 therefrom.

Referring to FIGS. 10-12, a user can mount the candle assembly 1032 on the CD player 1012 by first orienting the candle assembly 1032 to produce alignment between the guide posts 1138 of the CD player 1012 and the guide pockets 1140 of the end plate 1050 of the candle assembly 1032. No particular guide post 1138 needs to be aligned with a specific guide channel 1140, since the polarity-sensitive photo detector 1076 and its leads 1084 are a pre-assembled part of the CD player 1012, and not of the candle assembly 1032. Once alignment between the guide posts 1138 and the guide pockets 1140 is achieved, the candle assembly 1032 is lowered onto the CD player 1012 such that the lens-equipped end 1078 of the optical fiber 1048 is inserted first into the boot 1080, and then into the fiber guide 1110 for optical connection/alignment with the photo detector 1076. The candle 1038 is then lit, activating the CD player 1012 via candlelight transmitted and focused on the photo detector 1076 by the lens 1134.

It should be appreciated that the audio playback/candle assembly 1010 of FIGS. 10-12 provides numerous additional advantages over the prior art discussed above. For instance, the use of the guiding posts 1138 and guiding pockets 1140, as well as the guiding tube 1124 and fiber guide 1110 as described above, provides superior alignment and optical coupling between the optical fiber 1048 and the photo detector 1076. More particularly, simultaneous insertion of the guiding posts 1138 into the guiding pockets 1140 provides good vertical alignment of the candle assembly 12 as it is being attached to the CD player 12, and the guiding tube 1124 is sized and/or shaped so as to become centered within the cylindrically-shaped portion 1114 of the fiber guide 1110. Further, equipping the CD player 1012, rather than the candle assembly 1032, with the photo detector 1076 and the light-tight boot 1080, could reduce the complexity of and/or decrease the unit cost of manufacture of the candle assembly 1032, while not significantly increasing the unit cost of manufacture of the CD player 1012.

It should also be noted that the audio playback/candle assembly 1010 can have numerous modifications and variations. For example, and as illustrated in FIG. 13, the lens 1134 may be made a part of the CD player 1012, with respect to which it may be enclosed within a lens chamber 1144 of the CD player 1012. The lens chamber 1144 includes a cylinder 1146 that is at least partially hollow so as to accommodate the lens 1134 (and to permit the lens 1134 to focus candlelight on the photo detector 1076), and a transparent or translucent top panel 1148. The lower end 1078 of the optical fiber 1048, which in this example need not necessarily be enclosed within a guiding tube, extends through the hole 1136 of the end plate 1050 and contacts or otherwise faces the top panel 1148 directly. Such an arrangement is advantageous because the optical characteristics of the lens 1134 can forgive considerable misalignment between the optical fiber 1048 and the lens 1138 (e.g., even with such misalignment, the lens 1134, which is positioned substantially at its focal length from the photo detector 1076, will still collect substantially all the light from the optical fiber 1048 and focus the same on the photo detector 1076). Further, the cylinder 1146 may include an air flow channel similar to the air flow channels 1142 of the guide posts 1138, as shown in FIGS. 11 and 12.

The lens 1134 of the audio playback/candle assembly 1010 shown in FIGS. 10-12 can be eliminated in a modification thereof in which no lens is disposed between the end 1078 of the optical fiber 1048 and the photo sensor 1076. As such, the end 1078 of the optical fiber 1048 is not necessarily separated by a focal length from the photo sensor 1076, but instead can be positioned as near as is practicable to the photo sensor 1076 and/or in contact with the same.

It will be understood that the embodiments of the present invention described herein are merely exemplary and that a person skilled in the art may make many variations and modifications without departing from the spirit and scope of the invention. All such variations and modifications, including those discussed above, are intended to be included within the scope of the invention as defined in the appended claims.

1. Apparatus for playing back a recording, comprising a candle; a playback device including receiving means for receiving a storage medium having a recording stored therein for playback by said device, said receiving means being adapted to removably receive the storage medium such that the storage medium can be replaced by another storage medium with a different recording; and enabling means for enabling said device to play the recording stored in the storage medium when said candle is lit, said enabling means disabling said device when said candle is not lit.

2. The apparatus of claim 1, further comprising supporting means for removably supporting said candle on said device.

3. The apparatus of claim 2, wherein said enabling means includes sensing means for sensing light generated by said candle, said enabling means enabling said device to play the recording stored in the storage medium when said sensing means senses light generate by said candle.

4. The apparatus of claim 3, wherein said sensing means is formed as an integrated unit with said candle so as to be removed from said device together therewith.

5. The apparatus of claim 4, wherein said device includes a control circuitry therein, said enabling means including connecting means for electrically connecting said sensing means to said control circuitry so as to enable said device to play the recording stored in the storage medium when said sensing means senses light generated by said candle.

6. The apparatus of claim 5, wherein said connecting means includes a plurality of first electrical contacts connected to said sensing means and forming a part of said integrated unit.

7. The apparatus of claim 6, wherein said connecting means includes a plurality of second electrical contacts positioned on said device and connected to said control circuitry, each of said first electrical contacts being in contact with a corresponding one of said second electrical contacts when said candle is properly placed on said device.

8. The apparatus of claim 7, wherein said sensing means includes an optical sensor, which is mounted to a lower end of said candle and connected to said first electrical contacts, an optical conduit, which extends through said candle from said optical sensor to an upper end of said candle, and a boot, which receives a lower end of said optical conduit and covers at least a portion of said optical sensor for optically connecting said optical conduit to said optical sensor.

9. The apparatus of claim 8, wherein said candle includes an end plate attached to said lower end of said candle, said end plate covering substantially the entire surface of said lower end of said candle, said candle being positioned on one side of said end plate, and said first contacts being positioned on an opposite side of said end plate.

10. The apparatus of claim 9, wherein said supporting means includes a substantially annular wall located on said device and sized and shaped so as to receive said end plate and said lower end of said candle for supporting said candle on said device, said annular wall and said plate including aligning means for properly aligning said each of said first electrical contacts with said corresponding one of said second electrical contacts, said aligning means including at least one tab and at least one keyway.

11. The apparatus of claim 3, wherein said sensing means includes an optical conduit, which extends through said candle, and an optical sensor, which is affixed to said device, said sensing means including connecting means for optically connecting said optical conduit to said optical sensor such that said device can be enabled when said optical sensor receives light generated by said candle through said optical conduit.

12. The apparatus of claim 11, wherein said connecting means includes a lens positioned between said optical conduit and said optical sensor such that light can be transmitted from said optical conduit toward said optical sensor through said lens.

13. The apparatus of claim 12, wherein said optical conduit includes an end, said lens being positioned adjacent to said end of said optical conduit, said lens forming a part of said integrated unit such that it is removable from said device together with said candle.

14. The apparatus of claim 12, wherein said lens is affixed to said device.

15. The apparatus of claim 1, wherein said enabling means causes said device to play the recording stored in the storage medium when said candle is lit.

16. A recording playback device comprising a housing; receiving means for receiving a storage medium having a recording stored therein, said receiving means being adapted to removably receive the storage medium such that the storage medium can be replaced by another storage medium with a different recording; playing means for playing the recording of the storage medium received in said receiving means; and enabling means for enabling said playing means to play the recording stored in the storage medium when a candle supported on said housing is lit, said enabling means disabling said playing means when the candle is not lit.

17. The device of claim 16, wherein said housing includes supporting means for removably supporting the candle on said housing.

18. A compact disc player comprising a housing; receiving means for removably receiving a compact disc having a recording stored therein; playing means for playing the recording of the compact disc received in said receiving means; and enabling means for enabling said playing means to play the recording stored in the compact disc when a candle supported on said housing is lit.

19. The compact disc player of claim 18, wherein said housing includes supporting means for removably supporting the candle on said housing.

20. The compact disc player of claim 19, wherein said enabling means disables said playing means when the candle is not lit.
